(19) United States
(12) Patent Application Publication
(10) Pub. No.: US 2013/0183227 A1
(43) Pub. Date: Jul. 18, 2013

(54) THERMOPLASTIC LIGNIN FOR PRODUCING CARBON FIBERS

(71) Applicants: Bernd Wohlmann, Dusseldorf (DE); Michael Wolki, Dusseldorf (DE); Silke Stusgen, Neuss (DE)

(72) Inventors: Bernd Wohlmann, Dusseldorf (DE); Michael Wolki, Dusseldorf (DE); Silke Stusgen, Neuss (DE)

(73) Assignee: TOHO TENAX EUROPE GMBH, Wuppertal (DE)

(21) Appl. No.: 13/823,987

(22) PCT Filed: Sep. 8, 2011
(86) PCT No.: PCT/EP2011/065513

§ 371 Date: Mar. 15, 2013

(30) Foreign Application Priority Data
Sep. 23, 2010 (EP) 10178760.4

(51) Int. Cl. C07G 1/00

(52) U.S. Cl. CPC C07G 1/00
USPC 423/447.4; 530/500; 264/8

(57) ABSTRACT

A fusible lignin has a gas transition temperature in the range between 90 and 160° C. determined using differential scanning calorimetry (DSC), a molar mass distribution with a dispersivity of less than 28, determined using gel permeation chromatography (GPC), an ash content of less than 1 wt. %, and a proportion of volatile components of a maximum of 1 wt. %. Also provided is a precursor fiber based on the fusible lignin, as well as a method for the production thereof Also provided is a method for producing a carbon fiber from the precursor fiber.

The invention relates to a thermoplastic, fusible lignin which is suitable for the production of carbon fibers.

Lignin is considered to be the second most common polymer, after cellulose, made from the group of renewable raw materials. Lignin accumulates in large amounts in the paper and pulp industry. In this case, lignin accumulates as a byproduct of processes which are used industrially to isolate cellulose from lignocellulosic materials

These lignins, which occur naturally and are chemically bonded to the cellulose, are generally designated as “proto-lignins”. These proto-lignins are complex substances having a non-uniform polymer structure made of repeating elements such as cumaryl alcohol, sinapyl alcohol, and coniferyl alcohol. The method by means of which the lignin is separated from the cellulose, and particularly the method by means of which the lignin is reclaimed, influences the structure of the lignin. In the literature and also conjunction with the present application, lignin will therefore be understood not as the naturally occurring proto-lignin but rather as lignin obtained after the reclamation process, which is also designated as technical lignin.

Source materials include conifers (softwoods), such as fir, larch, spruce, pine, etc., or deciduous trees (hardwoods), such as willow, poplar, linden, beech, oak, ash, eucalyptus, etc., but annuals, such as straw or bagasse, can also be considered. In order to isolate the cellulosic fibers from these lignocellulosic materials, the lignocellulosic materials are subjected to a treatment, during which the lignin is brought into solution to a great enough extent that the cellulosic fibers can be isolated from the resulting aqueous slurry. The dissolved lignin remains in solution.

In approximately 80 percent of the technical pulp processing, the pulping takes place using the so-called sulfate method, also known as the Kraft process. In this case, the degradation of the lignins takes place using hydrogen sulfide (HS⁻) ions in a basic environment at approximately pH 13, due to the use of sodium sulfide (Na₂S) and sodium hydroxide (NaOH) or soda lye. The process takes approximately two hours at temperatures of approximately 170° C.; however, the ions also degrade the cellulose and the hemicelluloses, due to which only a partial pulping is possible. The waste liquor from this process, also called black liquor, contains solid material, which is approximately 45%, when pulping conifers, and approximately 38%, when pulping hardwoods, of the so-called Kraft lignin or alkali lignin.

A possibility for extracting lignin from the black liquor of the Kraft process is the so-called LignoBoost technology, in which the lignin is extracted from the black liquor via precipitation and filtration. During this process, the pH value is lowered by injecting CO₂ in order to precipitate the lignin. A method of this type is described for example in WO 2006/031175.

Further methods for extracting lignin from lignocellulosic materials include the soda (Na₂CO₃.10H₂O) method and the soda anthraquinone (AQ) method, in which the anthraquinone serves as a catalyst for a better delignification. In these methods as well, a black liquor is obtained, which contains the lignin to be extracted.

More recent developments use organic solvents for pulping biomasses. For example, the organosolv method functions using a system made of water and alcohol. Likewise, the so-called “steam explosion” process is used, in which, after a pretreatment with e.g. Na₂SO₃, NaHCO₃ and Na₂CO₃, lignocellulosic materials are hydrolytically split using pressurized, saturated steam at high temperatures in the range from 170 to 250° C. for a relatively short period of time, followed by an explosive-like decompression in order to abruptly terminate the boiling-up process.

The sulfite process represents a further alternative in cellulose pulping, in which the degradation of the lignin takes place due to sulfonation. Lignosulfonic acid results as a not-exactly-defined chemical reaction product of the lignin with the sulfurous acid. Lignosulfonic acid calcium salts result from pulping the wood with calcium hydrogen sulfite solutions. In this case, the waste liquor contains solid material in the form of lignosulfonic acid, approximately 55% when using conifers, and approximately 42% when using hardwoods. As mentioned, this pulping method does not generate lignin, but rather lignosulfonic acid and/or a lignosulfonic acid salt.

Depending on the method necessary for the pulping process, the processes required for recovering and isolating the lignins, such as acid precipitation from the black liquor, influence the characteristics of the lignin obtained, e.g. the purity, the structural uniformity, the molecular weight, or the molecular weight distribution. In general, it is noted that the lignins obtained after the pulping have a significant heterogeneity regarding the structure thereof.

Lignin as a byproduct of the production of cellulose has had, up until now, only limited commercial use and is for the most part disposed of as waste or burned for energy production. Various methods have been tried to produce valuable products from lignin. Thus, for example, U.S. Pat. No. 3,519,581 describes the production of synthetic lignin-polyisocyanate resins through the reaction of alkali lignins with organic polyisocyanates. U.S. Pat. No. 3,905,926 discloses lignin derivatives which contain polymerizable oxirane groups. The lignin derivatives disclosed in this document can be polymerized and used for various industrial purposes. DE 100 57 910 A1 describes a method for the derivatization of technical lignin, i.e. mixtures of lignins and decomposition products from the waste liquor associated with the pulping processes for extracting cellulose. According to DE 100 57 910 A1, the derivatization takes place by reacting the technical lignin with a spacer having at least one nucleophilic functional group. The purified lignin thus obtained can for example by processed using injection molding or extruding.

Attempts have also been made to use lignins inter alia for the production of fibers and particularly carbon fibers. In U.S. Pat. No. 5,344,921, for example, a process for producing a modified lignin is described, said lignin being spinnable into carbon fibers. The modified lignin is obtained by using a phenol to convert lignin into a phenolized lignin. The phenolized lignin is further heated in a non-oxidizing atmosphere, by which means a polycondensation of the phenolized lignins results, said polycondensation leading to an increase in the viscosity of the lignin solution, and a lignin suitable for spinning is obtained.

Lignins or lignin derivatives suitable for the production of carbon fibers are also disclosed in WO 2010/081775. This citation relates to lignin derivatives in which the free hydroxyl groups from the original lignin have been derivatized with monovalent and divalent radicals. The lignin derivatized in this way can be spun into fibers, said fibers able to be carbonized using common methods into non-thermoplastic, stabilized fibers and in a further step into carbon fibers.

U.S. Pat. No. 3,461,082 discloses a method for producing carbon fibers, in which method a lignin fiber is spun according to a dry or a wet spinning method from a solution of alkali lignin, thiolignin, or lignin sultanate using relatively large amounts of polyvinyl alcohol, polyacrylonitrile, or viscose, and subsequently heated to a sufficiently high temperature above 400° C. such that graphitization of the lignin fiber occurs.

DE 2 118 488 also discloses a method for producing lignin fibers and obtaining carbon fibers by carbonizing and if necessary graphitizing the same, in which method the lignin fibers are spun from solutions. According to DE 2 118 488, the spinning solutions are aqueous solutions of lignosulfonic acid or lignosulfonic acid salts, which contain, in addition to the lignin component, in proportions up to 2 wt. %, high-molecular components, such as polyethylene glycol or acrylic acid-acrylamide with a degree of polymerization above approximately 5,000. The lignin solutions are preferably spun into fibers using a dry spinning method.

US 2008/0317661 A1 relates to a method for producing carbon fibers from a conifer Kraft lignin. The lignin, which is extracted from a black liquor containing a softwood lignin, is then acetylated to obtain a fusible lignin acetate. The lignin acetate is extruded into a lignin fiber and the fiber obtained is subsequently thermally stabilized. The thermally stabilized softwood lignin acetate fiber is then subjected to carbonization.

The known methods for producing fibers and further for producing carbon fibers from lignin begin with chemically modified or derivatized lignins and/or use lignin solutions or solutions of lignin derivatives to produce the fibers. Insofar as a fiber production based on lignin raw materials takes place from the melt, the addition of considerable quantities of additives or solvent components is necessary to obtain a mixture which can be thermoplastically worked from a melt and can form filaments. Conducting processes using the known methods is, however, complex. In addition, the derivatizations and/or the additives can detrimentally affect the stabilization of the spun fibers based on lignin raw materials and the subsequent carbonization into carbon fibers.

As a result, there is a need for improved lignins which can be spun into fibers well and which are particularly suited for the production of carbon fibers.

The present invention relates therefore to a fusible lignin which has
a glass transition temperature in the range between 90 and 160° C. determined using differential scanning calorimetry (DSC) according to DIN 53765-1994,
a molecular weight distribution with a dispersivity of less than 28, determined using gel permeation chromatography (GPC),
an ash content of less than 1 wt. % determined according to DIN EN ISO 3451-1, and
a proportion of volatile components of at most 1 wt. % determined by means of the weight loss after 60 min at a temperature of 50° C. above the glass transition temperature T_{G} and at standard pressure.

As a basis for the fusible lignin according to the invention, lignins can be used from hardwoods such as beech, oak, ash, or eucalyptus, as well as from conifers, such as pines, larches, spruces, etc (softwood lignin). The lignins can be extracted using various pulping methods. In particular, the lignins can be extracted using sulfate methods, also known as Kraft processes, also in combination with the LignoBoost process, the soda AQ method, the organosolv method, or the steam explosion method as well. Lignin sufonates, as extracted, e.g. using sulfite methods, are, however, not to be understood as lignins in the context of the present invention.

Depending on the respective pulping process, lignins as well as in part relatively volatile decomposition components of lignin accrue, such as cumaryl alcohol, coniferyl alcohol, and sinapyl alcohol and the derivatives thereof, such as syringa or guaiacyl aldehyde, syringol, guaiacol; short-chain condensation products like esters, ethers or hemiacetals; and decomposition products of the lignocellulosic containing material, like glucose, xylose, galactose, arabinose, mannose, etc., or the decomposition products thereof, in various proportions. This mixture of lignin and decomposition products, which mixture can be extracted from the waste liquor of the associated process, is subsequently designated as technical lignin, or lignin for short.

Thus, in the context of the present invention, a lignin is understood to be a lignin obtained as a product of the previously listed pulping methods. This lignin is also designated as free lignin. Lignin salts, such as lignosulfonates, as are obtained in sulfite methods, are not considered to be lignins in the context of the present invention. Similarly not considered to be lignins in the context of the present invention are lignin derivatives in which lignins were modified via chemical reactions of lignin, e.g. via acetylation, acylation, esterification, etc., or e.g. via reactions with isocyanates.

The lignin according to the invention can be obtained from the lignins extracted via methods like the Kraft process, the soda AQ process, or the organosolv process, through extraction using suitable solvents or through fractionation by means of a mechanical separation method, which also includes ultrafiltration- or nanofiltration-membrane methods. The solvents to be used for an extraction involving solvents depend on the characteristics of the source material. Thus, e.g., an extraction using methanol, propanol, dichloromethane, or using a mixture of these solvents can be carried out in order to obtain, after subsequent precipitation from these solvents or after evaporating the solvent, a lignin with the characteristics required according to the invention. It is also possible to isolate various fractions of the lignin source material using the previously named solvents, and to taylor the fusible lignin according to the invention through suitable mixing of the fractions. The exact composition of the fractions thereby depends on the respective source lignin, for example whether it is a hardwood or a softwood lignin. It is also possible to combine suitable fractions from hardwood lignin and softwood lignin with one another.

It is decisive for the spinnability of the lignins from the melt that the lignins can actually be melted. They must therefore have a melting temperature or a melting temperature range. For characterization, the glass transition temperature T_{G} can be used, which is commonly used for polymers, which, inter alia, is influenced by molecular structure and molar mass and which can be determined by differential scanning calorimetry (DSC). The fusible lignin according to the invention has a glass transition temperature T_{G} in the range between 90 and 160° C. At the same time, said lignins have a molecular weight distribution or molar mass distribution with a dispersivity of less than 28. In the production of fibers from fusible lignin, it has been found that proportions of very high-molecular lignins are disruptive to the spinning process. Thus, spinning failure in melt spinning processes has been observed at increasingly high-molecular proportions in the lignin, possibly caused by non-melted regions, thus by inhomogeneities in the melt. On the other hand, too high a proportion of low-molecular components in the melt potentially leads to an improvement in the spinnability; however, this also leads to a distinct lowering of the glass transition temperature of the lignin and thus to difficulties in stabilizing lignin precursor fibers produced from a material of this type to transition into an oxidized, infusible state. Therefore, the glass transition temperature preferably lies in the range between 110 and 150° C. It is likewise preferred if the dispersivity of the molecular weight distribution is less than 15 and particularly preferred if it is less than 8.

The determination of the molar mass distribution takes place in the context of the present invention by means of gel permeation chromatography (GPC) on Pullulan standards of sulfonated polystyrene with dimethyl sulfoxide (DMSO)/0.1 M LiBr as the eluent and at a flow rate of 1 ml/min. The sample concentration is 2 mg/ml, and the injection volume is 100 μm. The furnace temperature is set to 80° C., and the detection takes place using UV light with a wave length of 280 nm. The number average M_{N} and the weight average M_{W} of the molar mass distribution are determined according to common methods from the molar mass distribution. The dispersivity results from the ratio of the weight average M_{W} to the number average M_{N}, thus M_{W}/M_{N}.

The molecular weight distribution is preferably monomodal. During spinning of the lignin according to the invention, it was found that it can be unfavorable in respect of the spinnability of the lignin if, e.g., the lignin is composed of two fractions with strongly divergent average molecular weight and at the same time a narrow molecular weight distribution. In this case, it can occur that the fractions melt at different temperatures, which results in an inhomogeneous spinning behavior. The lignin according to the invention should therefore preferably be fusible into a monophase melt. It is likewise advantageous if the molecular weight distribution of the lignin according to the invention is monomodal. A monomodal molecular weight distribution without shoulders is particularly preferred.

In the production of lignin fibers by means of a melt spinning process, it was found that bubbles often formed in the spinneret, which thus led to interruptions in the spinning or to the formation of pores in the resulting fibers. It is believed that this can be ascribed to the fact that low-molecular components, which include, for example, hemicelluloses, short-chain condensation products, and decomposition products such as sugar, already evaporate at the spinning temperature. The lignin according to the invention therefore has a proportion of volatile components of at most 1 wt. % and preferably of at most 0.8 wt. %, as determined by means of the weight loss after 60 min at a temperature of 50° C. above the glass transition temperature T_{G} and at standard pressure. This can be achieved in that, during the production of the lignin according to the invention, the lignin, which already has the other characteristics according to the invention, is subjected in an additional and preferred step to a thermal post-treatment. During this thermal post-treatment, the lignin is exposed to a temperature of 180° C. under vacuum for 2 h. Alternatively, separation methods by means of ultrafiltration or nanofiltration membranes, e.g. in the form of ceramic membranes, can also be used.

With regard to the spinnability of the lignin according to the invention as well as to the subsequent processing into stabilized precursor fibers and into carbon fibers, it has been found that it is important that the lignin should have as high a purity as possible. It has thus been shown that impurities and in particular metal salts lead to imperfections and pores in the fibers during the fiber production and especially during the carbonization into carbon fibers. The lignin according to the invention therefore has an ash content of less than 1 wt. % as determined according to DIN EN ISO 3451-1. The ash content is preferably less than 0.2 wt. % and particularly preferably less than 0.1 wt. %. The adjustment of the required ash content can be achieved for example by washing the lignin with acids such as hydrochloric acid and subsequently with desalinated water. Alternatively, purification by means of e.g. ion exchange is also possible.

The lignin according to the invention is fusible and has thermoplastic characteristics. It can be processed using methods common for thermoplastics into corresponding shaped bodies. Therefore, a shaped body which comprises the lignin according to the invention is likewise part of the present invention. Shaped bodies of this type can be produced from the lignin according to the invention using processing methods such as kneading, extruding, melt spinning, or injection molding at temperatures in the range from 30° C. to 250° C. and can have any form such as films, membranes, fibers, etc. In the range of higher processing temperatures of preferably approximately 150° C. to 250° C., the processing of the lignin according to the invention into a shaped body can take place in an inert gas atmosphere.

An embodiment of the invention relates to a fiber which comprises the fusible lignin according to the invention. Within the context of the present invention, a fiber is understood as a single thread, e.g. in the form of a monofilament, a multifilament fiber, an endless fiber, i.e. a yarn, or a short fiber. Preferably, the fiber according to the invention is a multifilament yarn. In particular, this fiber is a precursor fiber for carbon fibers, i.e. a fiber which is suitable as source material for the production of carbon fibers.

A precursor fiber of this type for carbon fibers is produced, according to one aspect of the present invention, by a method which comprises the following steps:
Provision of a fusible lignin according to the invention,
Melting of the lignin at a temperature in the range from 170 to 210° C. into a lignin melt and extruding the lignin melt into a lignin fiber through a spinneret heated to a temperature in the range from 170 to 210° C., and
Cooling the lignin fiber.

In a preferred embodiment of the method, the lignin fiber is a multifilament yarn made from a multiplicity of filaments, in which the diameter of the filaments lies in the range from 5 to 100 μm and particularly preferably in the range from 10 to 60 μm. The lignin fiber is preferably subjected to drawing after exiting the spinneret.

The invention further relates to a method for producing a carbon fiber comprising the following steps:
Provision of a precursor fiber comprising a fusible lignin according to the invention,
Stabilization of the precursor fiber at temperatures in the range from 150 to 400° C., by which means the precursor fiber is converted via chemical stabilization reactions from a thermoplastic into an oxidized, infusible state.
Carbonization of the stabilized precursor fiber.

A stabilization of precursor fibers for carbon fibers is generally understood as the conversion of the fibers, via chemical stabilization reactions, in particular via cyclization reactions and dehydration reactions, from a thermoplastic state into an oxidized, infusible and at the same time flameproof state. Stabilization in general takes place today in conventional convection furnaces at temperatures between 150 and 400° C., preferably between 180 and 300° C., in a suitable process gas (see, e.g. F. Fourné: “Synthetische Fasern”, Carl Hanser Verlag, Munich, Vienna, 1995, section 5.7). In this case, an incremental conversion of the precursor fiber from a thermoplastic into an oxidized, infusible fiber takes place via an exothermic reaction (J.-B. Donnet, R. C. Bansal: “Carbon Fibers”, Marcel Dekker, Inc., New York and Basel, 1984, pages 14-23). However, methods for stabilization by means of high-frequency electromagnetic waves can also be used, as are described e.g. in the unpublished PCT application PCT/EP2010/062674. Likewise, stabilization by means of UV radiation is possible. Within the context of the present invention, a process gas containing oxygen is preferably used during the stabilization.

The process step subsequent to the stabilization, that of carbonizing the stabilized precursor fiber according to the invention, takes place in an inert gas atmosphere, preferably using nitrogen. The carbonization can be carried out in one or more steps. During the carbonization, the stabilized fiber is heated at a heating rate that lies in the range from 10 K/s to 1 K/min, preferably in the range from 5 K/s to 1 K/min. The carbonization takes place at a temperature between 400 and 2000° C. Preferably, the final temperature of the carbonization has a value of up to 1800° C. The process step of carbonization converts the stabilized precursor fiber according to the invention into an carbonized fiber according to the invention, i.e., into a fiber in which the fiber-forming material thereof is carbon.

Following the carbonization, the carbonized fiber according to the invention can be further refined in the process step of graphitization. The graphitization can thereby be carried out in a single step, wherein the according to the invention carbonized fiber is heated in an atmosphere which consists of a monatomic inert gas, preferably argon, at a heating rate in the range from preferably 5 K/s to 1 K/min to a temperature of for example up to 3000° C. The process step of graphitization converts the carbonized fiber according to the invention into an graphitized fiber according to the invention. The implementation of the graphitization during the drawing of the carbonized fiber according to the invention leads to a significant increase in the modulus of elasticity of the resulting graphitized fiber according to the invention. Therefore, the graphitization of the carbonized fiber according to the invention is preferably carried out during simultaneous drawing of the fiber.

The invention will be explained in more detail on the basis of the following examples, wherein the scope of the invention is not limited by the examples.

### COMPARATIVE EXAMPLE 1

A hardwood lignin (eucalyptus), extracted from the black liquor of a Kraft process, was used. The lignin had a glass transition temperature T_{G} of 114° C., an average molecular weight M_{W} of 1270 g/mol, a molar mass distribution with a dispersivity of 4.1, and an ash content of 0.33 wt. %. The proportion of volatile components of this lignin was 2.48 wt. %.

The lignin was examined for spinnability by means of a standard spin tester (LME, SDL Atlas). The lignin could indeed be converted into the melt state at temperatures above 170° C.; however it could not be spun into fibers.

### EXAMPLE 1

The lignin according to Comparative example 1 was used; however, it was subjected to a thermal post-treatment, in which the source lignin was heated at 180° C. in a vacuum of less than 100 mbar for 2 hours.

The post-treated lignin had a glass transition temperature T_{G} of 130° C., an average molecular weight M_{W} of 3070 g/mol, a molar mass distribution with a dispersivity of 10.8, and an ash content of 0.33 wt. %. The proportion of volatile components of the post-treated lignin was less than 1 wt. %.

The lignin was examined for spinnability by means of a standard spin tester (LME, SDL Atlas), wherein a rotor temperature of 185° C. and a spinning head temperature of 200° C. were set on the spin tester. The spinning speed was 114°m/min. As a result, monofilaments with a filament diameter of 90 μm were produced from the post-treated lignin.

### COMPARATIVE EXAMPLE 2

A beechwood lignin was used that was extracted from a Kraft process. The beechwood lignin had a glass transition temperature T_{G} of 130° C., an average molecular weight M_{w} of2070 g/mol, and a molar mass distribution with a dispersivity of 9.3. The ash content was 0.45 wt. % and the proportion of volatile components was 2.29 wt. %.

This beechwood lignin was subjected to a spin test. No monofilaments could be produced; a stable spinning process was not achieved.

### EXAMPLE 2

The lignin from Comparative example 2 was subjected to purification and fractionation, i.e. a separation of the high-molecular components. In this case, the lignin was dissolved in a solvent at a ratio of 1:10 for 30 min with continuous stirring. A propanol/dichloromethane mixture in the ratio 20:80 was used as the solvent. The solution was filtered in a vacuum using a filter (S&S 595, 4-7 μm, Schleicher & Schüll), in order to separate insoluble components. Subsequently, the solvent was separated using a rotary evaporator.

The lignin thus purified and fractionated was then subjected to a thermal post-treatment in a vacuum of less than 100 mbar and heated at 180° C. for 2 hours.

The thermally post-treated lignin had a glass transition temperature T_{G} of 142° C., an average molecular weight M_{w} of 9970 g/mol, and a dispersivity of the molecular weight distribution of 27.5. The proportion of volatile components was 0.58 wt. % and the ash content was below 0.2 wt. %.

The lignin thus prepared could be spun using a standard spin tester (LME, SDL Atlas) into monofilaments with a filament diameter of 87 μm, which were usable as precursor fibers. In this case, a rotor temperature of 180° C. and a spinning head temperature of 195° C. were set at the spin tester.

### EXAMPLE 3

A hardwood lignin (eucalyptus), extracted from the black liquor of a Kraft process via the LignoBoost technology, was used as the source material. The source material was, as described in Example 2, initially subjected to purification and fractionation, wherein 1-propanol was used as the solvent.

The purified and fractionated lignin had a glass transition temperature T_{G} of 132° C., an average molecular weight M_{W} of 1902 g/mol, a molar mass distribution with a dispersivity of 2.1, and a proportion of volatile components of 1.30 wt. %. The ash content was below 0.2 wt. %.

To remove volatile components, the purified lignin was subsequently subjected to a thermal post-treatment in a vacuum of less than 100 mbar and heated at 180° C. for 2 hours. The lignin thus thermally post-treated had a glass transition temperature T_{G} of 146° C., a dispersivity of the molecular weight distribution of 2.3 and a proportion of volatile components of 0.71 wt. %. The ash content was likewise below 0.2 wt. %.

The lignin thus prepared could be spun using a standard spin tester (LME, SDL Atlas) into a monofilament, with a filament diameter in the range from 25-40 μm, which was usable as a precursor fiber. In this case, a rotor temperature of 185° C. and a spinning head temperature of 195° C. were set at the spin tester. The spinning speed was 114 m/min.

### EXAMPLE 4

A softwood lignin (larch and pine), extracted from the black liquor of a Kraft process via the LignoBoost technology, was used as the source material. The lignin obtained from the LignoBoost process had a glass transition temperature T_{G} of 173° C., an average molecular weight M_{W} of 7170 g/mol, and a molar mass distribution with a dispersivity of 17.6. The proportion of volatile components was above 2.0 wt. %.

The source material was initially subjected to purification and fractionation, which proceeded as in Example 3.

To remove volatile components, the purified lignin was likewise subjected to a thermal post-treatment in a vacuum of less than 100 mbar and heated at 180° C. for 2 hours. The lignin thus post-treated had a glass transition temperature T_{G} of 118° C., a dispersivity of the molecular weight distribution of less than 10, and a proportion of volatile components of 0.9 wt. %. The ash content was below 0.3 wt. %.

Monofilaments with a filament diameter in the range from 21-51 μm were spun from the lignin thus prepared by means of a standard spin tester (LME, SDL Atlas), wherein a rotor temperature of 175° C., a spinning head temperature of 185° C., and a spinning speed of 114 m/min were set as parameters at the spin tester.

### EXAMPLE 5

A softwood lignin (pine) obtained from a Kraft process with a glass transition temperature T_{G} of 153.3° C., an average molecular weight M_{W} of 4920 g/mol, and a molar mass distribution with a dispersivity of 9.0 was used. The ash content of the lignin was above 1 wt. % and the proportion of volatile components was above 2.0 wt. %.

The source material was, as described in Example 2, initially subjected to purification and fractionation, wherein, unlike Example 2, methanol was used as the solvent. To remove volatile components, the lignin thus prepared was likewise subsequently subjected to a thermal post-treatment in a vacuum of less than 100 mbar and heated at 180° C. for 2 hours.

After the thermal treatment, the lignin had a glass transition temperature T_{G} of 145° C., a dispersivity of the molecular weight distribution of 10.3 and a proportion of volatile components of less than 0.3 wt. %. The ash content was below 0.7 wt. %.

The lignin could be spun error-free into monofilaments in the spinning test. A rotor temperature of 180° C., a spinning head temperature of 210° C., and a spinning speed of 114 m/min were set as the parameters in the spinning test.

### EXAMPLE 6

A beechwood lignin from a soda anthraquinone process having a glass transition temperature T_{G} of 128° C. and a proportion of volatile components of 2.89 wt. % was used. This lignin was, as described in Example 2, subjected to purification and fractionation. The purified and fractionated lignin was then likewise subjected to a thermal post-treatment in a vacuum of less than 100 mbar and heated at 180° C. for 2 hours.

The thermally post-treated lignin had a glass transition temperature T_{G} of 132° C., an average molecular weight M_{W} of 6640 g/mol, and a dispersivity of the molecular weight distribution of 18.7. The proportion of volatile components was 0.75 wt. % and the ash content was below 0.05 wt. %.

In the spinning test, monofilaments with a filament diameter in the range from 21-43 μm were produced. A rotor temperature of 180° C., a spinning head temperature of 195° C., and a spinning speed of 91 m/min were set on the spin tester.

### COMPARATIVE EXAMPLE 3

A softwood lignin (pine) obtained from a Kraft process with a glass transition temperature T_{G} of 153° C. and an average molecular weight M_{W} of 3659 g/mol was used. The softwood lignin had a dispersivity of 2.61, an ash content of 4.08 wt. %, and a proportion of volatile components of 2.5 wt. %.

This softwood lignin could not be spun into fibers in the spin tester.

### COMPARISON EXAMPLE 4

A lignin obtained from annuals was used, said lignin being obtained via a soda method. The lignin made from annuals had a glass transition temperature T_{G} of 155° C., an average molecular weight M_{W} of 2435 g/mol, a dispersivity of 2.35, an ash content of 1.29 wt. %. and a proportion of volatile components of 2.6 wt. %.

This lignin made from annuals could not be spun.

### EXAMPLE 7

The monofilament obtained in Example 2 was used and under exposure to air was subjected to an oxidation treatment to produce a stabilized precursor fiber. For this, a segment of the monofilament obtained in Example 2 was subjected to a temperature treatment in a furnace in an air atmosphere and free from tension, wherein the furnace temperature was increased from 25° C. to 170° C. at 2° C./min and from 170° C. to 250° C. at 0.2° C./min. After reaching a furnace temperature of 250° C., the monofilament was further treated at 250° C. for 4 hours. This resulted in an infusible, stabilized precursor fiber with a density of 1.441 g/cm³, a tensile strength of 36 MPa, and an elongation of 0.67%.

### EXAMPLES 8a AND 8b

The monofilament obtained in Example 3 was used and was subjected to an oxidation treatment under exposure to air to produce a stabilized precursor fiber. Segments of the monofilament obtained in Example 3 were subjected to a temperature treatment in a furnace in an air atmosphere and free from tension. In Example 8a, the furnace temperature was increased from 25° C. to 170° C. at 2° C./min and from 170° C. to 250° C. at 0.2° C./min. After reaching a furnace temperature of 250° C., the monofilament was further treated at 250° C. for 4 hours. In Example 8b, the furnace temperature was increased from 25° C. to 170° C. at 2° C./min and subsequently from 170° C. to 300° C. at 0.2° C./min. After reaching a furnace temperature of 300° C., the monofilament was further treated at 300° C. for 2 hours.

In each case, this resulted in an infusible, stabilized precursor fiber. The stabilized precursor fiber produced according to the process conditions according to Example 8a had a density of 1.409 g/cm³, a tenacity of 116.5 MPa, and an elongation of 6.5%. The stabilized precursor fiber resulting from the application of the process conditions according to Example 8b had a density of 1.559 g/cm³, a tenacity of 154.1 MPa, and an elongation of 7.2%.

### EXAMPLES 9a AND 9b

The monofilament obtained in Example 4 was used and was subjected to an oxidation treatment under exposure to air to produce a stabilized precursor fiber. For this, a segment of the monofilament obtained in Example 4 was subjected to a temperature treatment in a furnace in an air atmosphere and free from tension. In this case, the furnace conditions set in Example 8a were also used in Example 9a and those in Example 8b were used in Example 9b.

In each case, this resulted in an infusible, stabilized precursor fiber. The stabilized precursor fiber produced according to the process conditions according to Example 9a had a density of 1.414 g/cm³, a tenacity of 118.6 MPa, and an elongation of 6.9%. The stabilized precursor fiber resulting from the application of the process conditions according to Example 9b had a density of 1.531 g/cm³, a tenacity of 193.9 MPa, and an elongation of 2.5%.

### EXAMPLES 10a AND 10b

The monofilament obtained in Example 6 was used and was subjected to an oxidation treatment under exposure to air to produce a stabilized precursor fiber. For this, a segment of the monofilament obtained in Example 6 was subjected to a temperature treatment in a furnace in an air atmosphere and free from tension. Thereby, the furnace conditions set in Example 8a were also used in Example 10a and those in Example 8b were used in Example 10b.

In each case, this resulted in an infusible, stabilized precursor fiber. The stabilized precursor fiber produced according to the process conditions according to Example 10a had a density of 1.425 g/cm³, a tenacity of 129 MPa, and an elongation of 4.8%. The stabilized precursor fiber resulting from the application of the process conditions according to Example 10b had a density of 1.448 g/cm³, a tenacity of 213 MPa, and an elongation of 5.0%.

### EXAMPLE 11

A stabilized precursor fiber produced according to Example 8b was used. A segment of the stabilized precursor fiber was fixed at the ends thereof in a carbonizing furnace and held under a tension of 0.5 cN. The carbonization furnace with the fiber segment was initially flushed with nitrogen for 1 h. After the flushing process, the carbonization furnace was heated from 25° C. to 800° C. at 3° C./min. By this means, the stabilized precursor fiber was carbonized in a nitrogen atmosphere.

A carbon fiber was obtained with a density of 1.554 g/cm³ and a carbon proportion greater than 80 wt. %. The carbon fiber had a tenacity of 599 MPa and an elongation at break of 1.1%.

### EXAMPLE 12

A stabilized precursor fiber produced according to Example 10b was used. The carbonization of the stabilized precursor fiber was carried out as in Example 11.

This resulted in a carbon fiber with a density of 1.502 g/cm³, a tenacity of 331 MPa, and an elongation at break of 0.7%. The carbon proportion in the fiber was significantly above 70 wt. %.

1. A fusible lignin which has
a glass transition temperature T_{G} in the range between 90 and 160° C. determined using differential scanning calorimetry according to DIN 53765-1994,
a molar mass distribution with a dispersivity of less than 28, determined using gel permeation chromatography,
an ash content of less than1 wt. %, determined according to DIN EN ISO 3451-1, and
a proportion of volatile components of at most 1 wt. %, determined by the weight loss after 60 minutes at a temperature of 50° C. above the glass transition temperature T_{G} and at standard pressure.

2. A fusible lignin according to claim 1, wherein the molecular weight distribution is monomodal.

3. A fusible lignin according to claim 1, wherein the molecular weight distribution is monomodal and without shoulders.

4. A fusible lignin according to claim 1, wherein the fusible lignin has a proportion of volatile components of a maximum of 0.8 wt. %, determined by the weight loss after 60 minutes at a temperature of 50° C. above the glass transition temperature T_{G} and at standard pressure.

5. A fusible lignin according to claim 1, wherein the fusible lignin has a glass transition temperature in the range between 110 and 150° C.

6. A fusible lignin according to claim 1, wherein the molecular weight distribution has a dispersivity lower than 15.

7. A fusible lignin according to claim 1, wherein the fusable lignin has an ash content less than 0.2 wt. %.

8. A method for producing a precursor fiber for carbon fibers comprising the steps:
provision of a fusible lignin according to claim 1,
melting of the lignin at a temperature in the range from 170 to 210° C. into a lignin melt and extruding the lignin melt into a lignin fiber through a spinneret heated to a temperature in the range from 170 to 210° C., and
cooling the lignin fiber.

9. A method for producing a precursor fiber according to claim 8, wherein the lignin fiber is a multifilament yarn consisting of a multiplicity of filaments in which the diameter of the filaments lies in the range from 5 to 100 μm.

10. A method for producing a precursor fiber according to claim 9, wherein the diameter of the filaments lies in the range from 10 to 60 μm.

11. A precursor fiber comprising a lignin according to claim 1.

12. A method for producing a carbon fiber comprising the steps:
use of a precursor fiber produced according to a method in accordance with claim 8:
stabilization of the precursor fiber at temperatures in the range from 150 to 400° C., during which the precursor fiber is converted via chemical stabilization reactions from a thermoplastic into an oxidized, infusible state, and
carbonization of the stabilized precursor fiber.

13. A method for producing a carbon fiber according to claim 12, wherein the stabilization of the precursor fiber takes place in an oxygen-containing process gas.
